(19) United States
(12) Patent Application Publication
(10) Pub. No.: US 2008/0250605 A1
(43) Pub. Date: Oct. 16, 2008

(54) Hinge unit and container having the same

(75) Inventor: Soung-joon Park, Gwangju (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 12/010,876

(22) Filed: Jan. 30, 2008

(30) Foreign Application Priority Data
Apr. 13, 2007 (KR) 10-2007-0036286

(51) Int. Cl. E05D 7/10; E05D 1/06

(52) U.S. Cl. 16/268; 16/260

(57) ABSTRACT

A hinge unit which rotatably supports a door with respect to a main body, the hinge unit includes: a hinge which is provided to one of the door and the main body; a hinge supporting unit which comprises a hinge accommodating part which accommodates the hinge; and a main body coupling part which detachably couples the hinge supporting unit with respect to the other of the door and the main body by insertion.

### CROSS-REFERENCE TO RELATED APPLICATIONS

This application claims priority benefit from Korean Patent Application No. 10-2007-0036286, filed on Apr. 13, 2007 in the Korean Intellectual Property Office, the disclosure of which is incorporated herein by reference.

### BACKGROUND

1. Field

Embodiments relate to a hinge unit to assemble and disassemble a door and a main body without difficulty and a container having the same.

2. Description of the Related Art

The hinge unit includes a hinge pivot, a coupling unit coupling the hinge pivot to the main body, and a hinge pivot accommodating unit provided to the door to accommodate the hinge pivot. Accordingly, the door can rotate with respect to the main body on the hinge pivot.

However, in the conventional hinge unit, since the coupling unit coupling the hinge pivot is coupled to the main body by a screw, a rivet or the like, assembling and disassembling thereof requires a lot of time, and it is necessary to troublesomely use a separate working tool such as a driver, etc.

### SUMMARY

Accordingly, in an aspect of embodiments, there is provided a hinge unit to assemble and disassemble a door and a main body without difficulty.

In another aspect of embodiments, there is provided a container having a hinge unit to assemble and disassemble a door and a main body without difficulty.

The foregoing and/or other aspects of embodiments can be achieved by providing a hinge unit which rotatably supports a door with respect to a main body, the hinge unit including: a hinge which is provided to one of the door and the main body; a hinge supporting unit which includes a hinge accommodating part which accommodates the hinge; and a main body coupling part which detachably couples the hinge supporting unit with respect to the other of the door and the main body by insertion.

According to an aspect of embodiments, the main body coupling part includes: a hook engagement part which is provided in one of the main body and the hinge supporting unit, and a hook which is provided in the other of the main body and the hinge supporting unit, and moves between a locking position in which the hook is coupled to the hook engagement part, and a withdrawing position in which the hook is withdrawn from being coupled with the hook engagement part.

According to an aspect of embodiments, the hook moves between the locking position and the withdrawing position by an elastic transformation.

According to an aspect of embodiments, the main body coupling part includes: a separation preventing groove which is recessed in one of the main body and the hinge supporting unit, and a separation preventing protrusion which protrudes from the other of the main body and the hinge supporting unit to be coupled to the separation preventing groove, and prevents the hinge supporting unit from being separated from the main body in the locking position.

According to an aspect of embodiments, one side of the hinge accommodating part is formed with an entrance part through which the hinge moves in and out, and the width of the entrance part is smaller than the diameter of the hinge.

The foregoing and/or other aspects of embodiments can be achieved by providing a container, including: a main body which includes an opening, and forms a storing space; a door which opens and closes the opening; and a hinge unit.

According to an aspect of embodiments, the door includes a door main body which covers the opening, and a door coupling unit which is provided in the door main body to be rotatably coupled with the main body, and the hinge protrudes from the door coupling unit.

According to an aspect of embodiments, the hinge protrudes from the opposite end parts of the door coupling unit.

According to an aspect of embodiments, the main body is formed with a hinge mounting part which accommodates the hinge supporting unit.

According to an aspect of embodiments, the hinge mounting part is formed with an incised part which prevents rotation of the door coupling unit from interference.

The foregoing and/or other aspects of embodiments can be achieved by providing a container, including: a main body which includes an opening, and forms a storing space; a door which opens and closes the opening; and a hinge unit.

According to an aspect of embodiments, the door includes a door main body which covers the opening, and a door coupling unit which is provided in the door main body to be rotatably coupled with the main body, and the hinge protrudes from the door coupling unit.

According to an aspect of embodiments, the hinge protrudes from the opposite end parts of the door coupling unit.

According to an aspect of embodiments, the main body is formed with a hinge mounting part which accommodates the hinge supporting unit.

According to an aspect of embodiments, the hinge mounting part is formed with an incised part which prevents rotation of the door coupling unit from interference.

According to an aspect of embodiments, there is provided a method for assembling a door with respect to a main body with a hinge unit including coupling the separation preventing protrusion of the main body coupling part with the separation preventing groove of the other of the door and the main body; and coupling the hinge supporting unit to a hinge mounting part which is provided on the other of the door and the main body using a main body coupling part.

### BRIEF DESCRIPTION OF THE DRAWINGS

These and/or other aspects, features, and advantages will become apparent and more readily appreciated from the following description of exemplary embodiments, taken in conjunction with the accompanying drawings of which:

FIG. 1 is a perspective view of a container including a hinge unit according to an exemplary embodiment;

FIG. 2 is an exploded perspective view of the container including the hinge unit according to an exemplary embodiment;

FIGS. 3A and 3B are sectional views taken along line III-III in FIG. 1 to illustrate an operating state of a hinge supporting unit of the hinge unit according to an exemplary embodiment; and

FIG. 4 is a sectional view illustrating a door opening and closing state of the container according to an exemplary embodiment.

### DETAILED DESCRIPTION OF EMBODIMENTS

Reference will now be made in detail to exemplary embodiments, examples of which are illustrated in the accompanying drawings, wherein like reference numerals refer to the like elements throughout. Exemplary embodiments are described below by referring to the figures.

A hinge unit 50 according to an exemplary embodiment is applied to a container 1. Alternatively, the hinge unit 50 may be applied to various apparatuses, for example a door of an apparatus which upwardly rotates with respect to a main body, such as a refrigerator, an accommodating apparatus, a copy machine, etc.

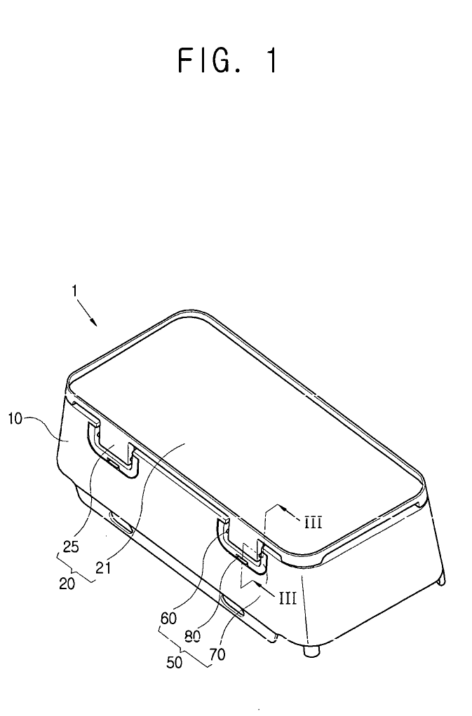

Hereinafter, the hinge unit 50 and the container 1 having the same according to an exemplary embodiment will be described in detail by referring to FIGS. 1 to 4.

As shown in FIGS. 1 to 4, the container 1 according to the exemplary embodiment of the present invention includes a main body 10 having an opening 11, a door 20 opening and closing the opening 11, and the hinge unit 50 rotatably supporting the door 20 with respect to the main body 10.

A storing space 13 is formed in an inner portion of the main body 10. The storing space 13 has the opening 11 in an upper side thereof. A hinge mounting part 15 is recessed from an outer surface of the main body 10 in a perimeter of the opening 11 of the main body 10 so that the hinge unit 50 can be mounted thereto. The hinge mounting part 15 has a shape corresponding to a hinge supporting unit 70. Accordingly, the hinge unit 50 can be prevented from protruding from an outer surface of the main body 10 while the hinge unit 50 is coupled to the main body 10 and the door 20.

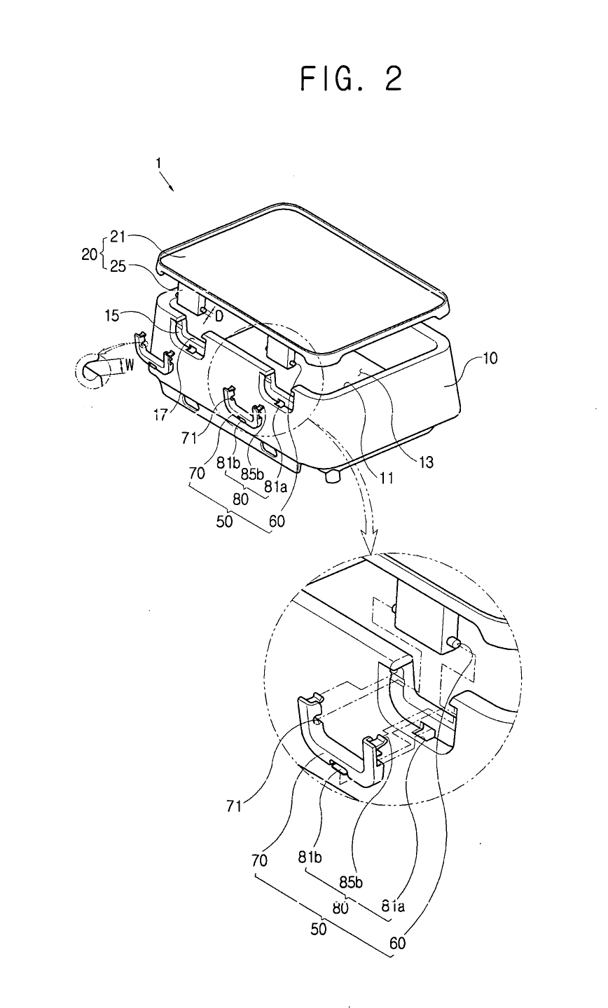

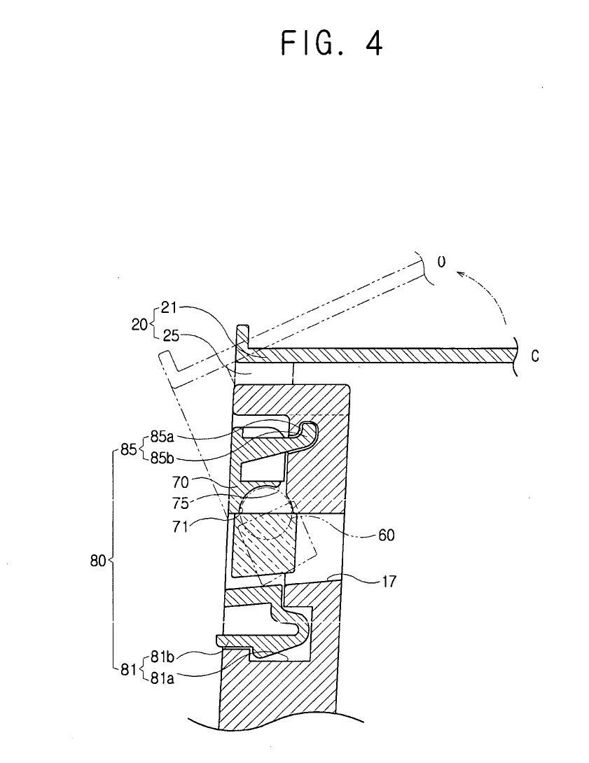

The door 20 opens and closes the opening 11 of the main body 10. As shown in FIGS. 2 and 4, the door 20 moves between a closing position C in which the door 20 closes the opening 11 by the hinge unit 50, and an opening position O in which the door 20 opens the opening 11. The door 20 includes a door main body 21 covering the opening 11, and a door coupling unit 25 provided to the door main body 21 to be rotatably coupled with the main body 10.

The door coupling unit 25 protrudes from an end part of the door main body 21 in a transverse direction with respect to a planar direction of the door main body 21. As shown in FIG. 2, the door coupling unit 25 according to the present exemplary embodiment is provided in a pair. Alternatively, the door coupling unit 25 may be provided singly, or at least in triplicate.

The hinge unit 50 includes a hinge 60 provided to the door 20, the hinge supporting unit 70 having a hinge accommodating part 71 accommodating the hinge 60, and a main body coupling part 80 detachably coupling the hinge supporting unit 70 with respect to the main body 10.

The hinge 60 is provided in a pair to protrude from the opposite end parts of the door coupling unit 25.

The hinge supporting unit 70 includes the hinge accommodating part 71 accommodating the hinge 60. The hinge supporting unit 70 has a shape corresponding to the door coupling unit 25, and is formed in an approximate widened-U shape to surround the door coupling unit 25. The hinge accommodating part 71 is formed in the opposite end parts of the hinge supporting unit 70.

The hinge accommodating part 71 is formed penetratingly in an axis direction of the hinge 60, and has an internal diameter, the size of which corresponds to the size of an external diameter of the hinge 60. A side of the hinge accommodating part 71 is formed with an entrance part 75 through which the hinge 60 moves in and out. An area of the hinge accommodating part 71 is opened to form the entrance part 75 so that the hinge 60 can be coupled to the hinge accommodating part 71 in a transverse direction with respect to the axis direction of the hinge 60. Here, the hinge 60 is forcedly inserted to the hinge accommodating part 71 to be coupled thereto. The width W of the entrance part 75 is small in comparison with the diameter D of the hinge 60 to prevent the hinge 60 from being separated from the hinge accommodating part 71. Accordingly, the hinge 60 and the hinge accommodating part 71 can be coupled and assembled without difficulty. The entrance part 75 is formed toward the main body 10. Accordingly, the hinge 60 can be prevented from being arbitrarily separated from the hinge accommodating part 71 while the hinge supporting unit 70 is coupled to the main body 10.

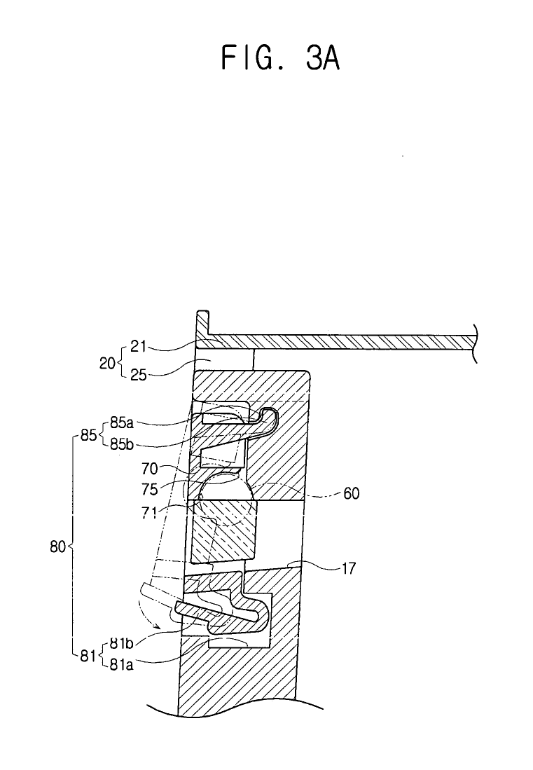

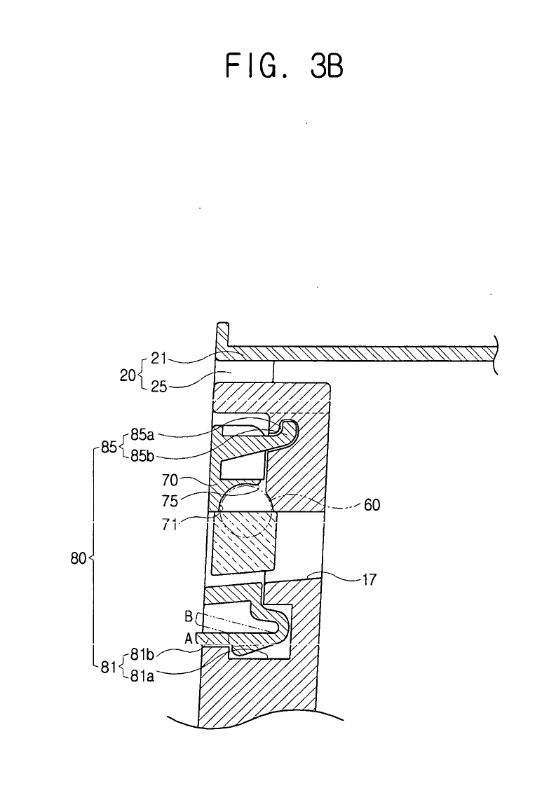

As shown in FIGS. 2 and 3A, a surface of the hinge mounting part 15 facing the entrance part 75 is recessed to accommodate the hinge 60 which outwardly protrudes from the hinge accommodating part 71 through the entrance part 75.

The main body coupling part 80 detachably couples the hinge supporting unit 70 with respect to the main body 10. The main body coupling part 80 includes a hook engagement part 81a provided in one of the main body 10 and the hinge supporting unit 70, and a hook 81b provided in the other of the main body 10 and the hinge supporting unit 70. The hook 81b according to the present exemplary embodiment is provided in the hinge supporting unit 70, and the hook engagement part 81a is provided in the hinge mounting part 15 of the main body 10.

The hinge mounting part 15 is recessed from an outer surface of the main body 10. Here, the hook engagement part 81a is recessed from the hinge mounting part 15.

The hook 81b is provided to the hinge supporting unit 70 to move between a locking position A in which the hook 81b is coupled to the hook engagement part 81a, and a withdrawing position B in which the hook 81b is withdrawn from the hook engagement part 81a. As shown in FIG. 2, the hook 81b according to the present exemplary embodiment protrudes from a central area of a lengthwise direction of the hinge supporting unit 70 to the opposite direction of the door 20 to be bent. The hook 81b protrudes from the hinge supporting unit 70 to be bent multiple times. Here, the hook 81b is formed of an elastic material. Also, the hook 81b moves between the locking position A and the withdrawing position B by an elastic transformation. Hook engagement part 81a and hook 82b form a hook unit 81.

The main body coupling part 80 of the hinge unit 50 according to the present invention may further include a separation preventing groove 85a formed in the main body 10, and a separation preventing protrusion 85b protruding from the hinge supporting unit 70 to be coupled to the separation preventing groove 85a.

The separation preventing groove 85a is recessed from the hinge mounting part 15.

The separation preventing protrusion 85b is coupled to the separation preventing groove 85a in the locking position A to prevent the hinge supporting unit 70 from being separated from the hinge mounting part 15 of the main body 10. The separation preventing protrusion 85b protrudes from the opposite end parts of the hinge supporting unit 70. Separation preventing groove 85a and separation preventing protrusion 85b form a separation preventing unit 85.

In the present exemplary embodiment, the separation preventing groove 85a is recessed from the hinge mounting part 15 of the main body 10, and the separation preventing protrusion 85b is provided in the hinge supporting unit 70. Alternatively, the separation preventing groove 85a may be formed in the hinge supporting unit 70, and the separation preventing protrusion 85b may be provided in the hinge mounting part 15 of the main body 10.

The separation preventing protrusion 85b and the hook 81b may be positioned to face each other. Also, the positions of the separation preventing protrusion 85b and the hook 81b provided in the hinge supporting unit 70 may be exchanged. In this case, the positions of the separation preventing groove 85a and the hook engagement part 81a formed in the main body 10 may be exchanged.

Also, the separation preventing protrusion 85b may have a configuration similar to that of the hook 81b to be hook-coupled with respect to the main body 10.

By providing the main body coupling part 80 having this configuration, a load of the door 20 applied to the hinge accommodating part 71 in the opening position of the door 20 can be dispersed to the main body coupling part 80 to be supported with respect to the main body 10, thereby improving durability of the hinge unit 50.

The hinge mounting part 15 is formed with an incised part 17 preventing rotation of the door coupling unit 25 from being interfered. As shown in FIG. 2, the incised unit 17 has a shape corresponding to the door coupling unit 25, and is formed by incising the hinge mounting part 15. As shown in FIG. 4, the incised unit 17 prevents the door coupling unit 25 rotating on the hinge 60 when the door 20 rotates from the closing position C to the opening position O from being interfered by the main body 10.

In the present exemplary embodiment, the hinge 60 is provided in the door 20, and the hinge accommodating part 71 is provided in the hinge supporting unit 70. Alternatively, the hinge 60 may be provided in the hinge supporting unit 70, and the hinge accommodating part 71 may be provided in the door 20.

Also, in the present exemplary embodiment, the hinge mounting part 15 is provided in the main body 10, and the hinge supporting unit 70 is coupled to the main body 10. Alternatively, the hinge mounting part 15 may be provided in the door 20. In this case, the hinge 60 may be provided in the main body 10, and the hinge supporting unit 70 may be coupled to the door 20.

Also, in the present exemplary embodiment, the main body coupling unit 80 couples the hinge supporting unit 70 to the main body 10 by the hook coupling. Alternatively, the hinge supporting unit 70 may be inserted to the main body 10 to be coupled to the main body 10 by a sliding method.

Hereinafter, a coupling method and an operating method of the container 1 having the hinge unit 50 according to the present invention will be described by referring to FIGS. 2 to 3B.

At first, an assembling process of the container 1 according to the present invention will be described.

The hinge 60 is coupled to the hinge accommodating part 71. Here, if the entrance part 75 is pressed in the transverse direction with respect to the axis direction of the hinge 60, the hinge 60 is forcedly inserted to the hinge accommodating part 71 to be coupled thereto.

After the separation preventing protrusion 85b is coupled to the separation preventing groove 85a, the hinge supporting unit 70 is pressed toward the hinge mounting part 15 to couple the hook 81b and the hook engagement part 81a. If a user presses the hinge supporting unit 70 toward the hinge mounting part 15 after pressing the hook 81b toward the separation preventing protrusion 85b, the hook 81b can be more easily coupled to the hook engagement part 81a. Here, if the user presses the hook 81b toward the separation preventing protrusion 85b in the locking position A, the hook 81b is elastically transformed to move to the withdrawing position B. Also, if the hook 81b is withdrawn from being pressed after the hinge supporting unit 70 is completely accommodated to the hinge mounting part 15, the hook 81b moves from the withdrawing position B to the locking position A to be coupled to the hook engagement part 81a. Accordingly, the door 20 and the main body 10 can be assembled by one touch without difficulty.

The door 20 and the main body 10 may be disassembled in the reverse order to the assembling process.

Hereinafter, an opening and closing process of the door 20 of the container 1 having the hinge unit 50 according to the present invention will be described by referring to FIG. 4.

If a user holds and pushes the door 20 in an opening direction in the closing position C of the door 20, the door 20 rotates with respect to the main body 10 on the hinge 60 to move to the opening position O. Here, since the incised unit 17 is formed in the hinge mounting part 15, the main body 10 can be prevented from interfering with rotation of the door coupling unit 25.

With this configuration, the hinge unit 50 according to the present invention includes the hinge 60 provided in one of the door 20 and the main body 10, the hinge supporting unit 70 having the hinge accommodating part 71 accommodating the hinge 60, and the main body coupling unit 80 detachably coupling the hinge supporting unit 70 with respect to the other of the door 20 and the main body 10 by insertion. Accordingly, the door 20 and the main body 10 can be assembled and disassembled without difficulty, and durability of the hinge unit 50 can be improved.

As described above, exemplary embodiments provide a hinge unit for assembling and disassembling a door and a main body without difficulty, and a container having the same.

Although a few exemplary embodiments have been shown and described, it would be appreciated by those skilled in the art that changes may be made in these exemplary embodiments, the scope of which is defined in the claims and their equivalents.

What is claimed is:

1. A hinge unit which rotatably supports a door with respect to a main body, the hinge unit comprising:
a hinge which is provided to one of the door and the main body;
a hinge supporting unit which comprises a hinge accommodating part which accommodates the hinge; and
a main body coupling part which detachably couples the hinge supporting unit with respect to the other of the door and the main body by insertion.

2. The hinge unit according to claim 1, wherein the main body coupling part comprises:
a hook engagement part which is provided in one of the main body and the hinge supporting unit, and
a hook which is provided in the other of the main body and the hinge supporting unit, and moves between a locking position in which the hook is coupled to the hook engagement part, and a withdrawing position in which the hook is withdrawn from being coupled with the hook engagement part.

3. The hinge unit according to claim 2, wherein the hook moves between the locking position and the withdrawing position by an elastic transformation.

4. The hinge unit according to claim 2, wherein the main body coupling part comprises:
a separation preventing groove which is recessed in one of the main body and the hinge supporting unit, and
a separation preventing protrusion, which protrudes from the other of the main body and the hinge supporting unit to be coupled to the separation preventing groove, and which prevents the hinge supporting unit from being separated from the main body in the locking position.

5. The hinge unit according to claim 1, wherein one side of the hinge accommodating part is formed with an entrance part through which the hinge moves in and out, and
the width of the entrance part is smaller than the diameter of the hinge.

6. A container, comprising:
a main body which comprises an opening, and forms a storing space;
a door which opens and closes the opening; and
a hinge unit according to claim 1.

7. The container according to claim 6, wherein the door comprises a door main body which covers the opening, and a door coupling unit which is provided in the door main body to be rotatably coupled with the main body, and
the hinge protrudes from the door coupling unit.

8. The container according to claim 7, wherein the hinge protrudes from the opposite end parts of the door coupling unit.

9. The container according to claim 7, wherein the main body is formed with a hinge mounting part which accommodates the hinge supporting unit.

10. The container according to claim 9, wherein the hinge mounting part is formed with an incised part which prevents rotation of the door coupling unit from interference.

11. A container, comprising:
a main body which comprises an opening, and which forms a storing space;
a door which opens and closes the opening; and
a hinge unit according to claim 2.

12. The container according to claim 11, wherein the door comprises a door main body which covers the opening, and a door coupling unit which is provided in the door main body to be rotatably coupled with the main body, and
the hinge protrudes from the door coupling unit.

13. The container according to claim 12, wherein the hinge protrudes from the opposite end parts of the door coupling unit.

14. The container according to claim 13, wherein the main body is formed with a hinge mounting part which accommodates the hinge supporting unit.

15. The container according to claim 14, wherein the hinge mounting part is formed with an incised part which prevents rotation of the door coupling unit from Interference.

16. A method for assembling a door with respect to a main body with a hinge unit, comprising:
coupling a hinge which is provided to one of the door and the main body to a hinge accommodating part of a hinge supporting unit; and
coupling the hinge supporting unit to a hinge mounting part which is provided on the other of the door and the main body using a main body coupling part.

17. The method of claim 16, wherein:
the main body coupling part has a separation preventing protrusion, a separation preventing groove, a hook, and a hook engagement part, and
the separation preventing groove and the hook engagement part are provided on other of the door and the main body.

18. The method of claim 17, wherein coupling the hinge supporting unit to the hinge mounting part comprises:
coupling the separation preventing protrusion of the main body coupling part with the separation preventing groove of the other of the door and the main body; and
coupling the hook of the main body coupling part with the hook engagement part of the other of the door and the main body.
